(19) United States
(12) Patent Application Publication
(10) Pub. No.: US 2025/0299267 A1
(43) Pub. Date: Sep. 25, 2025

(54) INTEGRATED BEVERAGE CONTAINER MANAGEMENT SYSTEM WITH UNIQUE IDENTIFIER TECHNOLOGY

(71) Applicant: PerfectWerks Solutions Inc., Snoqualmie, WA (US)

(72) Inventor: Nils Lahr, Snoqualmie, WA (US)

(21) Appl. No.: 19/087,303

(22) Filed: Mar. 21, 2025

Related U.S. Application Data
(60) Provisional application No. 63/568,874, filed on Mar. 22, 2024.

(51) Int. Cl. G06Q 50/00; G06K 19/06; G06K 19/07

(52) U.S. Cl. CPC G06Q 50/01; G06K 19/06037; G06K 19/0723

(57) ABSTRACT

A beverage container management system integrates unique identification technology with a mobile application and a backend service to facilitate the management of container contents, sharing of recipes and notes, and social connectivity among users with similar beverage crafting interests. The beverage container can have an identifier attached thereto that is distinct, and the identifier can include one or more of a QR code, an RFID tag, and an IoT device.

### CROSS REFERENCE TO RELATED APPLICATION

This application claims the benefit of U.S. Provisional Patent Application No. 63/568,874, filed on Mar. 22, 2024, which is incorporated herein by reference in its entirety.

### FIELD

The present disclosure relates generally to systems, methods, and computer-readable mediums for managing containers, and particularly for managing beverage containers with unique identifiers.

### BACKGROUND

The increasing variety of beverages and larger container sizes pose a challenge in tracking the contents and details associated with each beverage container. Existing systems do not adequately address the need for content management, recipe sharing, and social connectivity based on beverage containers' content.

The subject matter claimed herein is not limited to aspects that solve any disadvantages or that operate only in environments such as those described above. Rather, this background is only provided to illustrate one exemplary technology area where some aspects described herein may be practiced.

### BRIEF SUMMARY

The present disclosure is related to systems, methods, and computer readable media for providing a novel system for identifying beverage containers, tracking their contents, and connecting users based on shared interests in beverage crafting, while facilitating content management and social interaction.

One aspect illustrated herein includes a system, which comprises a unique identifier (e.g., QR code, RFID tag, IoT device) for each container, a mobile application for data entry and management, and a backend service for data analysis and social networking.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific aspects which are illustrated in the appended drawings. Understanding that these drawings depict only typical aspects and are not therefore to be considered to be limiting in scope, aspects will be described and explained with additional specificity and detail through the use of the accompanying drawings in which:

FIG. 1 illustrates a block diagram of an integrated beverage container management system in accordance with aspects of the present disclosure;

FIG. 2 illustrates a graphical illustration of a screen on a mobile device for the integrated beverage container management system of FIG. 1 in accordance with aspects of the present disclosure; and

FIG. 3 illustrates a flow diagram for an authorization key generation system in accordance with aspects of the present disclosure.

FIG. 4 illustrates a flow chart diagram of a method for managing beverage container contents using a mobile application and backend service.

### DETAILED DESCRIPTION

The present disclosure is related to systems, methods, and computer readable media for providing a novel system for identifying beverage containers, tracking their contents, and connecting users based on shared interests in beverage crafting, while facilitating content management and social interaction. For example, a sticker, which includes a unique identifier, may be attached to each container, thereby identifying each container. Additionally or alternatively, a wired or wireless network interface may be added to each container so that any information associated with each container can be transmitted to a management server, which stores the transmitted information so that the transmitted information can be accessible by the public. Thereby, the public can find out the beverage content stored in each container.

In at least one embodiment, each container may include various sensors so that any changes to the beverage content in the container can be sensed and the sensed results can be transmitted to the management server as the information. Thus, the public can also access the changes to the beverage content.

Furthermore, the management server can save the information about each container and changes thereof in a blockchain ledger so that each piece of information can be immutably saved and cannot be tempered. Thereby, saving the information in the blockchain ledger can provide further assurance and credibility of the information to the public.

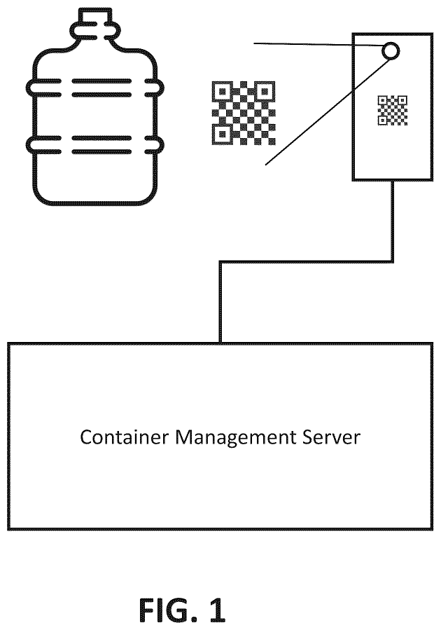

Referring now to FIG. 1, illustrated is a container management system for containers such as beverage kegs or even mugs. The container management system may provide immutability of information regarding the containers. When a user is provided with one or more containers, the user may use a user device to scan a unique identifier on a sticker. The unique identifier may be a barcode, QR code, a series of alphanumeric characters, or the like. The user device may be a smartphone, barcode or QR code scanner, or any other device, which can scan the unique identifier. In FIG. 1, the user device is a smartphone, as an example, and the user uses a camera to scan the unique identification in the sticker. The scanned unique identification is then registered as one of the user's containers via a container management server.

The user may have a user identification (ID) which is unique from IDs of the other users. Further, the scanned ID of the sticker may also be unique from IDs of stickers of the other beverage containers and is registered with the user ID so that the container associated with the unique ID is registered only with the user ID.

After scanning the unique ID, the mobile device may transmit the user ID and the unique ID of the container to the container management server. Then, the container management server registers the container with the user ID based on the scanned ID so that no other container with the same ID can be registered with any other users.

The unique ID in the sticker may be provided to the user separately from the container. The provider of the container may have a capacity or be able to generate the unique ID. When the user receives the sticker with the container, the user may be able to register the container based on the unique ID in the sticker.

In an aspect, the user may be able to generate the unique ID. For example, like a universal product code (UPC) code, the user may be able to generate the unique ID, which is different from all IDs generated by the other users. The unique ID may be a barcode, a quick response (QR) code, or any other images or alpha-numerals. In this way, the user may be able to rent the container with a generated unique ID. Thus, when a renter receives the container and the sticker having the unique ID, the renter may be able to register the container based on the sticker which holds the unique identification so that the container can be registered with the renter.

In an aspect, the unique ID may be generated by any other means to uniquely identify the container. For example, the unique ID may be generated based on at least one or any combination of the user ID, a location of the container, or the model ID of the container. This list is not meant to be limited thereto but provided as examples. Thus, this list may further include a shape of the container, the content of the container, or the likes.

In an aspect, the mobile device may be a virtual reality (VR) device, which is capable of identifying objects scanned by the VR device. In this regard, the VR device may include various sensors and one or more programs to detect an object, identify the object, and assign an identifier for the object. When an identifier is identified and assigned for the container by the VR device, this identifier may be used as the unique ID for the container. The VR device may be a VR headset, a smartphone, or any other smart device.

In an aspect, the sticker may comprise radiofrequency identification (RFID), Bluetooth, or near field communication (NFC) circuits or alternatively, the sticker may be integrated with the RFID circuit, Bluetooth circuit, NFC circuit, etc. such that the sticker is able to wirelessly transmit information to a device, which includes an RFID transceiver, a Bluetooth transceiver, or an NFC transceiver.

In an aspect, with regard to the registration, the container management server may register the container with the user or the renter based on the received unique ID, and/or store this registration information at its storage or at a blockchain ledger, which is immutable and can be accessible by the public.

The container may have several sensors, one of which is a pressure sensor. The pressure sensor senses the pressure or changes in the pressure in the container. The sensed information may include how much beverage or liquid is contained in the container and when the beverage in the container is leaked or supplied to clients. In at least one embodiment, the pressure sensor may be positioned at the bottom of the container. The pressure sensor senses the changes in the pressure. Pressure differences can be saved in a memory of the sensor, which can be transmitted later to the user device, which then transmits to the container management server. In an aspect, the pressure differences may be directly transmitted to the container management server by the sensor, when a network connection is made between them. In this way, the pressure changes can be recorded in the blockchain ledger.

Further, the container may have another pressure sensor, which measures the pressure of the gas in the container and is positioned at the top portion of the container. As the beverage is supplied, the pressure of the gas in the container may become smaller and smaller. Thus, based on the pressure of the remaining gas in the container, the amount of beverage in the container may be estimated or calculated. In an aspect, based on the pressures sensed by the pressure sensors at the bottom and top of the containers, the remaining beverage may be identified or estimated with high accuracy.

In another aspect, the container may have a level sensor, which can sense the level of beverage in the container. The changes in the level of the beverage in the container can be also stored in the memory of the sensor and transmitted later to the user device so that the user device can also transmit the change information to the container management server. The change in the level of beverage may be stored and registered at the memory of the container management server or at the blockchain ledger. In this regard, the container sensors and the user device are widely or wirelessly connected to each other via a router. The network connection may be in a local area network (LAN) or a wide area network (WAN).

With regarding to the network connection, the sensors of the container may be activated by radio frequency (RF) signals transmitted by an RFID transceiver, a Bluetooth transceiver, or a near field communication (NFC) transceiver. When the transceiver following RFID, Bluetooth, or NFC protocols comes into a proximity of the sensors, the sensors may be activated and perform transmission of information saved in the memory of each sensor. The transmitted information then can be transmitted to the transceiver, which can also transmit the information to the container management server.

The sensors may be powered by an external power source or battery integrated into the container. In this regard, the sensors are actively measuring the pressure or level of the beverage and transmitting the sensed data saved in the sensors to the container management server. The sensors may transmit the information periodically to the container management server or the user device in a predetermined period or on the fly. The predetermined period may be an hour, a day, a week, two weeks, a month, or any other period predetermined for maintaining the content in the container. In that regard, the sensor has memory, of which capacity can be sufficiently large to hold information sensed by sensor during the predetermined period.

In an aspect, the container may have a central memory where sensed data from all sensors are saved. When a network connection is made, the sensed data saved in the central memory may be collectively transmitted. In another aspect, each sensor may have its own memory. When a network connection is made, each sensed data may be individually transmitted to the user device or the container management server.

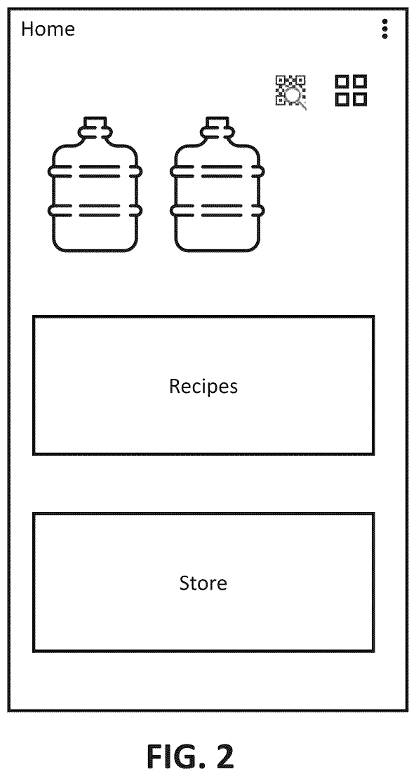

Now referring to FIG. 2, illustrated is a graphical representation of a mobile application screen of a user device. The mobile application is associated with the container management system. The mobile application screen has several items, which include a plurality of containers which have been registered with the user and a finding icon. When the user selects the finding icon, the user can scan the unique identification on a sticker via a camera, transceiver, or some other communication device, so that the container related to that sticker can be registered with the user.

After the user attaches the sticker to the container, third parties, consumers, or clients may be able to scan the sticker by using a camera so that they can also access the information of the container.

In an aspect, the sticker may include a network circuit, which can be activated by another device. For example, the sticker may be activated by a mobile device, which includes an RF transceiver, an NFC transceiver, or a Bluetooth transceiver. Specifically, when the transceiver of the mobile device transmits RF signals, which awake the sticker, the sticker transmits its unique ID to the mobile device. The information related to the container is accessible by the mobile device based on the unique ID via the container management server or the blockchain ledger. Thus, a consumer or any other interested party may bring their mobile devices in proximity to the sticker and access information of the container.

Now returning back to FIG. 2, after the user scans the unique ID or the sticker and registers the container, the newly registered container may appear on the mobile application screen. When the user selects an icon of the newly registered container, the user is able to add a description of the container, such as the type of beverage (e.g., Starbucks coffee, local band of beer, spirits, alcoholic beverage, carbonated soda, etc.) stored in the container, the date of filling the beverage into the container, the originating place of the beverage, expiration date of the beverage, a color of the container, a range of temperature for the beverage or the container, the date of purchase of the beverage or the container, or any other relevant information of the beverage and the container. After the user entered such information and when the user selects the container, the user may be able to access the log of all the changes sensed by the sensors of the container.

The user may be able to rent the container to a renter. Since the user can access the log of changes of the container, the user may be able to identify when the renter needs to refill the beverage into the container or repair the container. Further, the user may be able to check the log of the changes to find out whether the beverage goes bad based on the passage of time in consideration of the expiration date of the beverage. Further, based on the information log, the user may be able to identify any problems with the container and provide to the renter voluntary after-service for the container.

Now referring back to FIG. 2, the mobile application screen has a recipe section. By selecting the recipes section, the user may be able to provide the recipes of the beverage contained the container. For example, the recipe section may include the ingredients of the beverage contained in the contain and/or when and how to make the beverage. The mobile application screen also has a store section. The user may be able to provide any stores that provides the container and/or the beverage to be contained in the container so that the renter or other users may be able to find stores for the container and/or the beverage.

After all the beverage in the container is consumed or used, the user may be able to fill the container with a new beverage or refill it with the same beverage. In this way, the user may be able to reuse the container for another beverage or the same beverage later. In a case where a new beverage is filled in the container, the user may be able to access the log, clear the log, and restart the log for the new beverage. In a case where the log is saved in the blockchain, the user may be unable to clear the log but instead add new entries to the log for the container. Further, in an aspect, the mobile application of a consumer may be configured to access the log for the most recent beverage contained in the container. In other words, the mobile application of the consumer shows only the log related to the most recent beverage. On the other hand, the user or the renter may be able to access the entirety of the log for the container so that they can access how many different beverages have been contained in the container. In this way, the user or renter may be able to identify the lifetime of the container and know when to replace the container.

When the user selects a container in the mobile application screen, the user may be able to remove the selected container. On the other hand, any consumer is unable to remove the container and is able to only view the log of the container saved in the blockchain ledger.

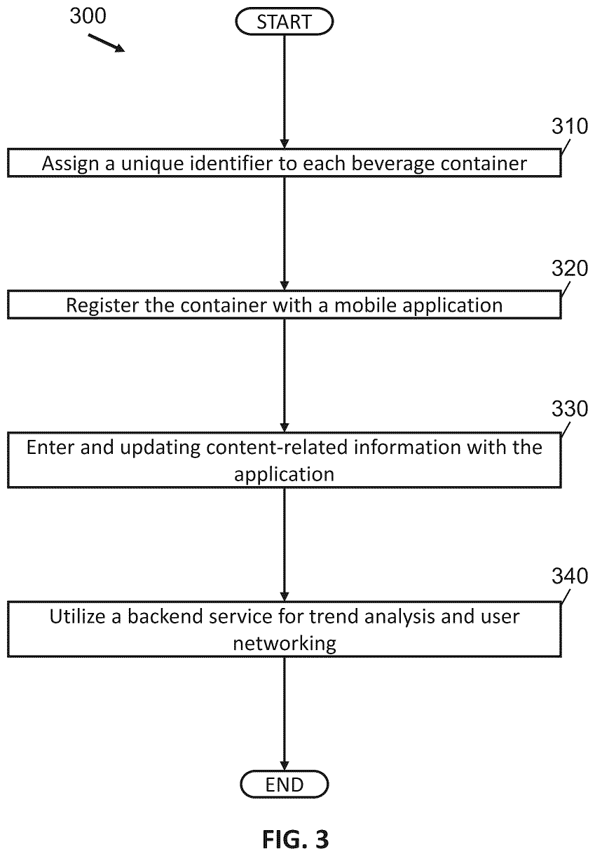

Referring now to FIG. 3, illustrated is a method of controlling content related information of each container. At step 310, a unique identification may be assigned to a respective container and the user is able to scan the unique identification so as to register the container with the user based on the unique ID by using a mobile device. The user may be able to look for and see information of the container via a mobile application at Step 320. As described above, the container has one or more sensors. Which one or more changes in the beverage contained in the container occur, such changes may be wirelessly or widely transmitted to a container management server, which can then store the information in the blockchain ledger.

The user may be able to enter and update content related information of the beverage or the container, such as the name of the container, the color of the container, the type of the beverage, the date of filling the beverage, the origin of the beverage, the expiration date of the beverage, etc. The recipe of the beverage may be entered into the mobile application. The user may be able to enter ingredients of the beverage in the recipe section. When the user enters those pieces of information to the mobile application, such information may be transmitted to the container management server, which then stores the information at its memory or at the blockchain ledger.

At step 340, a trend of changes in the beverage or the container may be analyzed by the container management server. Also, the container management server may utilize a backend service for the analysis. Based on the analysis, the container management server may be able to provide useful information of the container or the beverage. The useful information may be when to repair the container, when to refill the beverage, or when to provide a notice of any related services to the user or the renter.

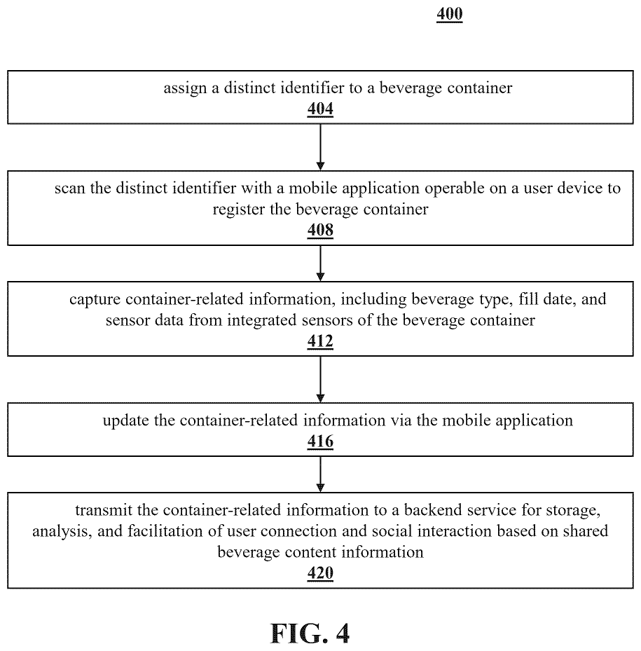

FIG. 4 shows an embodiment of a method 400 for managing beverage container contents. The method 400 involves assigning a distinct identifier to a beverage container 404, scanning the identifier with a mobile application 408, capturing container-related information, including beverage type, fill date, and sensor data from integrated sensors of the beverage container 412, updating the container-related information via the mobile application 416, and transmitting this information to a backend service for storage, analysis, and facilitation of user connection and social interaction based on shared beverage content information 420. This method can be implemented by a system as described in the patent draft, which includes a mobile application and a backend service.

At step 404, a distinct identifier is assigned to a beverage container. This identifier can be a QR code, an RFID tag, or an IoT device, which provides a specific identification for the container and facilitates management within the system.

At step 408, the distinct identifier is scanned using a mobile application operable on a user device. This step registers the beverage container within the system, allowing the user to manage and track the container's contents and related information, including beverage type, fill date, and sensor data from integrated sensors of the beverage container as captured in step 412.

At step 412, container-related information is captured, including beverage type, fill date, and sensor data from integrated sensors of the beverage container. This information provides a comprehensive overview of the container's contents and condition.

At step 416, the container-related information is updated via the mobile application 408. This step ensures that the information remains current and accurate, reflecting any changes in the container's contents or status.

At step 420, the container-related information is transmitted to a backend service for storage, analysis, and facilitation of user connection and social interaction based on shared beverage content information. This step enables the backend service to analyze the data and support user engagement through social networking features.

Computing system functionality can be enhanced by a computing systems' ability to be interconnected to other computing devices via network connections. Network connections may include, but are not limited to, connections via wireless connections including satellite, Ethernet, cellular connections, or wired connections including even computer to computer connections through serial, parallel, USB, or other connections. The connections allow a computing system to access services at other computing systems and to quickly and efficiently receive application data from other computing systems.

Interconnection of computing systems has facilitated distributed computing systems, such as so-called “cloud” computing systems. In this description, “cloud computing” may be systems or resources for enabling ubiquitous, convenient, on-demand network access to a shared pool of configurable computing resources (e.g., networks, servers, storage, applications, services, etc.) that can be provisioned and released with reduced management effort or service provider interaction. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

Cloud and remote based service applications are prevalent. Such applications are hosted on public and private remote systems such as clouds and usually offer a plurality of web based services for communicating back and forth with clients.

Many computers are intended to be used by direct user interaction with the computer. As such, computers have input hardware and software user interfaces to facilitate user interaction. For example, a modern general-purpose computer may include a keyboard, mouse, touchpad, camera, etc. for allowing a user to input data into the computer. In addition, various software user interfaces may be available. Examples of software user interfaces include graphical user interfaces, text command line based user interface, function key or hot key user interfaces, and the like.

Disclosed aspects may comprise or utilize a special purpose or general-purpose computer including computer hardware, as discussed in greater detail below. Disclosed aspects also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, aspects of the invention can comprise at least two distinctly different kinds of computer-readable media: physical computer-readable storage media and transmission computer-readable media. The transmission computer-readable media that carry computer-executable instructions may include signals, carrier waves, and propagating signals.

On the other hand, the physical computer-readable storage media may be volatile memory, which requires power to maintain stored information. The physical computer-readable storage media may be non-volatile memory, which retains stored information when the non-volatile memory is not powered. In some aspects, the non-volatile memory may include flash memory, dynamic random-access memory (DRAM), ferroelectric random-access memory (FRAM), or phase-change random access memory (PRAM). In some aspects, the computer-readable media may include, by way of non-limiting examples, CD-ROMs, DVDs, flash memory devices, magnetic disk drives, magnetic tapes drives, optical disk drives, and cloud computing-based storage. In some aspects, the computer-readable media may be a combination of devices such as those disclosed herein.

The physical computer-readable media may include executable instructions (e.g., codes, programs, algorithms, etc.). The executable instructions represent instructions that are executable by the processor. Further, the computer-readable media may exclude signals, carrier waves, and propagating signals.

Generally, a processor executes executable instructions stored in the computer-readable media. The processor may include, without limitation, Field-Programmable Gate Arrays (“FPGAs”), Program-Specific or Application-Specific Integrated Circuits (“ASICs”), Program-Specific Standard Products (“ASSPs”), System-On-A-Chip Systems (“SOCs”), Complex Programmable Logic Devices (“CPLDs”), Central Processing Units (“CPU”), Graphical Processing Units (“GPU”), or any other type of programmable hardware by performing the basic arithmetic, logical, control and input/output (I/O) operations specified by the instructions. As used herein, terms such as “executable module,” “executable component,” “component,” “module,” or “engine” may refer to the processor or to software objects, routines, or methods that may be executed by the processor. The different components, modules, engines, and services described herein may be implemented as objects, codes, programs, or libraries that the processor executes.

A general-purpose computer, special purpose computer, or special purpose processing device also includes a display, which may be a cathode ray tube (CRT), a liquid crystal display (LCD), light emitting diode (LED), or an organic light emitting diode (OLED) display. In some aspects, the OLED display is a passive-matrix OLED (PMOLED) or active-matrix OLED (AMOLED) display. In other aspects, the display may be a touch screen, through which alpha-numerals may be input or entered. In still other aspects, the display may be a hologram, through which users may enter data by touching or swiping space.

Data or commands may be entered via an input device in the special purpose or general-purpose computer. The input device may be a keyboard, a mouse, a touch screen, or a hologram keyboard.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry program code in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general-purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones tablets, mobile devices, smartphones, PDAs, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include FPGAs, ASICs, ASSPs, SOCs, CPLDs, etc.

The present system introduces a comprehensive method for managing beverage containers that integrates identification technology with a mobile application and a backend service. This system is designed to facilitate the identification of beverage containers, track their contents accurately, and connect users based on shared interests in beverage crafting. By leveraging identifiers such as QR codes, RFID tags, or IoT devices, the system enables seamless data entry and management through a mobile application. Additionally, a backend service is employed for data analysis and social networking, enhancing user interaction and content management. This innovative approach not only addresses the limitations of existing systems but also provides a platform for social connectivity and content sharing among users with similar interests.

### Examples

In a first example, a beverage container management system comprises a unique identifier associated with each beverage container; a mobile application for registering said containers and entering container-related information; and a backend service for data analysis and user connection based on shared content information.

In a second example using the system of the first example, wherein the unique identifier is selected from the group consisting of a QR code, an RFID tag, and an IoT device.

The system of the first or second examples, further comprising a low-power Bluetooth device integrated with the beverage container for real-time monitoring of container parameters.

In a third example, a method of managing beverage container contents comprises assigning a unique identifier to each beverage container; registering the container within a mobile application; entering and updating content-related information within the application; and utilizing a backend service for trend analysis and user networking.

In a fourth example, a non-transitory computer readable medium includes one or more programs stored thereon that, when executed by a computer, cause the computer to perform a method of managing beverage container contents, the method comprising assigning a unique identifier to each beverage container; registering the container within a mobile application; entering and updating content-related information within the application; and utilizing a backend service for trend analysis and user networking.

The present invention may be embodied in other specific forms without departing from its spirit or characteristics. The described aspects are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A beverage container management system, comprising:
a beverage container having attached thereto an identifier that is distinct, wherein the identifier is selected from the group consisting of a QR code, an RFID tag, and an IoT device;
a mobile application operable on a user device configured to register the beverage container using the specific identifier, capture container-related information including beverage type, fill date, and sensor data from integrated sensors, and update such information; and
a backend service communicatively coupled to the mobile application and the beverage container, wherein the backend service stores and analyzes the container-related information and facilitates user connection and social interaction based on shared beverage content information.

2. The system of claim 1, wherein the identifier is embedded within the container material for durability and tamper resistance, ensuring the integrity of the identification process.

3. The system of claim 1, wherein the identifier comprises a combination of a QR code and an embedded RFID chip.

4. The system of claim 1, wherein the mobile application supports multiple user devices, including smartphones, tablets, and smartwatches.

5. The system of claim 1, wherein the mobile application features an interface with customizable dashboards for displaying container data, improving user accessibility and engagement.

6. The system of claim 1, wherein additional sensors are integrated into the beverage container to measure parameters such as temperature, pH level, or carbonation, providing comprehensive data on beverage quality.

7. A method of managing beverage container contents, comprising:
assigning a distinct identifier to a beverage container, the identifier being selected from the group consisting of a QR code, an RFID tag, and an IoT device;
scanning the distinct identifier with a mobile application operable on a user device to register the beverage container;
capturing container-related information, including beverage type, fill date, and sensor data from integrated sensors of the beverage container;
updating the container-related information via the mobile application; and
transmitting the container-related information to a backend service for storage, analysis, and facilitation of user connection and social interaction based on shared beverage content information.

8. The method of claim 7, wherein the distinct identifier comprises a combination of a QR code and an RFID tag, providing enhanced security and redundancy.

9. The method of claim 8, wherein the identifier is generated based on at least one parameter selected from the group consisting of user ID, container location, and container model ID.

10. The method of claim 7, wherein the mobile application supports scanning using various devices, including smartphones, tablets, and smartwatches.

11. The method of claim 10, wherein the mobile application incorporates augmented reality (AR) or virtual reality (VR) capabilities to enhance the scanning process.

12. The method of claim 7, further comprising capturing additional sensor data, such as temperature, pH level, or carbonation, to provide comprehensive data on beverage quality.

13. The method of claim 12, wherein the mobile application features a customizable user interface for displaying container data, allowing users to personalize their experience.

14. The method of claim 7, wherein the container-related information is transmitted to a backend service using blockchain technology for secure and immutable storage.
